(19) United States
(12) Patent Application Publication
(10) Pub. No.: US 2005/0273547 A1
(43) Pub. Date: Dec. 8, 2005

(54) Method for balancing data access to non-volatile memory

(75) Inventors: Tony Tsai, Taipei Hsien (TW); David Ho, Taipei Hsien (TW); Wei Han, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/859,223

(22) Filed: Jun. 3, 2004

(51) Int. Cl. G06F 12/00

(52) U.S. Cl. 711/103

(57) ABSTRACT

The present invention discloses a method for balancing the data access to a non-volatile memory by sorting a block number of an unwritten memory block of a non-volatile memory with a queue structure. If the data in any memory block of the non-volatile memory is erased, the block number of the memory block in which the data is erased will be appended to the tail of the queue. If a data is written into the non-volatile memory, a block number of the memory block is obtained from the head of the queue and the desired data is written into the memory block with the corresponding block number, and in the meanwhile the block number is deleted from the queue.

### FIELD OF THE INVENTION

The present invention relates to non-volatile memories, more particularly to a method for balancing the number of data accesses to each block of a non-volatile memory in order to prolong the use life thereof.

### BACKGROUND OF THE INVENTION

Embedded systems are extensively used in many areas including mobile phones and computers, etc. and their memory module comprises a random access memory (RAM), a read only memory (ROM) and a flash memory; wherein the RAM is generally used for the instant data access of an embedded system; for example, after the system completes the data processing, the data are stacked and saved into a storage medium, etc.; the ROM is used for saving system data such as fonts and instructions, etc; and the flash memory is divided into several blocks, and the block is generally used for saving data, and the data stored in one or a plurality of memory blocks can be modified. When the data stored in the memory block is modified, it is necessary to erase the data in the memory block first and then write a new data into the memory block. In addition, if one of the blocks of the flash memory is damaged or unusable, then the entire flash memory will be damaged or cannot be used anymore. Further, the flash memory has a life with an upper limit of erases (for about 100,000 times of erases). If any one of the memory blocks reaches such limit, the entire flash memory cannot be used anymore. When the data stored in a general flash memory is modified, the data stored in the memory block is read out first and combined with the new data, and then the modified data is written into the memory block. Therefore, the number of accessing or modifying data in each memory block of the flash memory is not necessary the same. Therefore, the best way of extending the life of a flash memory is to have the same number of writing and erasing data for each memory block as much as possible. At present, there are two main methods of extending the life of the flash memory:

1. Daily log structure: The advantages of such method include the extension of the life of the flash memory and the protection against system crashes or power failures, and the disadvantages include the requirement for an additional program (such as the Windows reconfiguration utility program for recovering the data by reading records from the memory block one by one from a long list of sections; the more the records, the slower is the speed.).

2. Balanced data access method: When an embedded system is operating, the control system reads, writes, or modifies data in the flash memory by using the method for balancing the data access to a flash memory. When the data in a memory block is modified, all of the data stored in the memory block are read out first and then combined with the new data, and thus achieving less data access to the memory block, and also writing data into an empty memory block and erasing data stored in the original memory block. This method has the advantages of reading data fast and not producing disk fragments, but it does not support the protection for system crashes/power failures.

### SUMMARY OF THE INVENTION

In view of the shortcomings of the traditional method for extending the life of the flash memory, the inventor of the present invention conducted extensive researches and experiments and finally developed a method for balancing the data access to non-volatile memories according to the present invention. To achieve the above object, the present invention sorts a block number of an unwritten memory block of a non-volatile memory with a queue structure. If the data in any memory block of the non-volatile memory is erased, the block number of the memory block in which the data is erased will be appended to the tail of the queue; if it is necessary to write a data into the non-volatile memory, a block number of the memory block is obtained from the head of the queue and the desired data is written into the memory block corresponding to the block number and then the block number is erased from the queue.

The above and other objects, features and advantages of the present invention will become apparent from the following detailed description taken with the accompanying drawings.

### BRIEF DESCRIPTION OF THE DRAWINGS

FIG. 1 is a block diagram of the system of an embedded system.

FIG. 2 is a flow chart of saving modified data into the non-volatile memory according to the present invention.

### DETAILED DESCRIPTION OF THE PREFERRED EMBODIMENTS

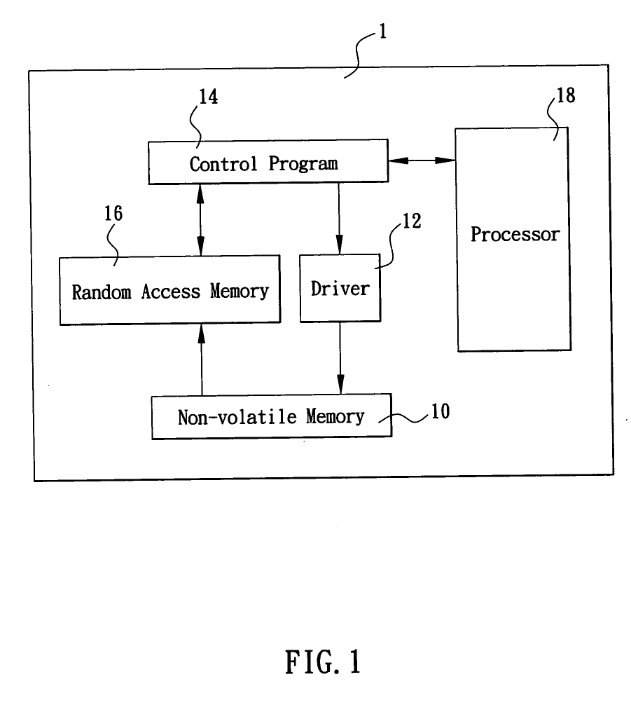

The invention discloses a method of balancing the data access of a non-volatile memory as shown in FIG. 1. The method makes use of an embedded system 1 comprised of a non-volatile memory 10 (such as a flash memory), a driver 12, a control program 14, a random access memory 16, and an arithmetic unit 18 (such as a central processing unit); wherein the non-volatile memory 10 saves data; the driver 12 controls the data access to the non-volatile memory 10, and the control program 14 sorts the queue structure for the block numbers of the non-volatile memory 10 and adds/deletes the block number to/from the queue. In the method for balancing the data access to a non-volatile memory according to the present invention, the random access memory 16 saves the logical mapping of the non-volatile memory 10, and the codes of the driver 12 and the control program 14. The arithmetic unit 18 controls the processing of all components in the system.

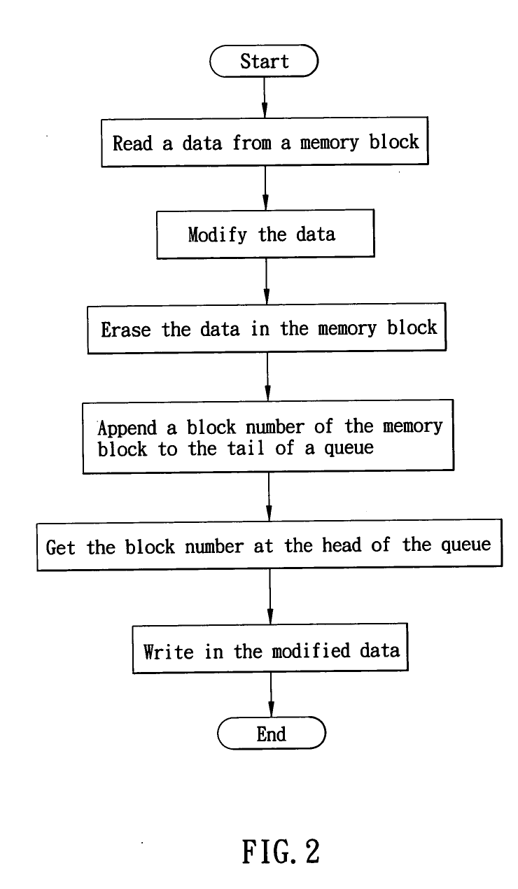

In the invention, the non-volatile memory 10 can be divided into a plurality of memory blocks, and each of the memory blocks is assigned with a unique block number, so that when an embedded system 1 is initialized, the control program 14 sorts the block numbers of unwritten memory blocks with a queue structure. If the driver 12 erases the data in any one of the memory blocks of the non-volatile memory, the block number corresponding to the memory block from which data is erased will be appended to the tail of the queue. After the driver 12 modifies and processes a data in one of the memory blocks and tries to write the data back into the non-volatile memory 10 or a new data is written into the non-volatile memory, the control program 14 will obtain a block number of a memory block from the head of the queue, and then writes the new data or the modified data into the memory block corresponding to the block number, while deleting the block number from the queue as shown in FIG. 2.

In the invention, the memory space occupied by the queue in the random access memory 16 queue is given in the formula below:
n×No. of memory blocks in a volatile memory;
where, n is the number of bytes occupied by each block number and determined by the control program 14. In the present invention, the number of bytes occupied by the block number is: [symbol]
n<□4;
and the queue is saved in the random access memory 16, and the control program 14 controls the sorting of the queue and the execution of the driver 12. The driver 12 is capable of reading, writing, and erasing the non-volatile memory 10, and also saving the data read from, modified for, or written into the memory block of the random access memory 16.

In summation of the described above, the computation is easy and the structure is simple. Furthermore, the embedded system 1 carries little extra load, and thus executing in a fast speed without generating any disk fragment. The present invention also provides better compatibility for the original document system since there are less modified sections in the embedded system 1. Further, the operation procedure of the traditional embedded system includes the steps of reading a data from the memory block, merging or modifying the data, erasing the read memory block, and writing the merged or modified data into the memory block. The operation procedure of the invention as shown in FIG. 2 is very similar to the operation procedure of the traditional embedded system, but the difference resides on that the erased memory block is not the same memory block for writing a new data according to the invention, and the queue is computed with a faster processing speed in the random access memory 16. Unlike the traditional method for balancing the data access to a non-volatile memory, the invention only requires a small space of the random access memory 16, and thus will not increase the operation load of the processor 18 too much for the computation of a small quantity of data.

The performance of the invention is related to the regular pattern of modifying or adding data. If other data have been modified once before the data in any memory block is modified again, then every memory block has a chance to enter into the queue. Therefore, the performance of the non-volatile memory is maximized if the increase of the number of erases in each memory block is synchronous and balanced. If some memory blocks have never been read or modified, then those memory blocks cannot enter into the queue, and then the increase of the number of erases in each memory block is not balanced, and only the number of erases for the memory blocks in the queue or the read or erased memory blocks is increased, which will lower the performance of the present invention. Therefore, the overall performance of the invention depends on the status of using the embedded system 2 by users.

A better understanding on the difference between using and not using the method of balancing the data access to a non-volatile memory and the advantages of adopting such method are given below:

If the data in other memory blocks have been modified once before the data in a memory block is modified again, then the maximum performance is achieved regardless of whether or not adopting the method of balancing the data access to the embedded system. In the case of not adopting such method, the number of writing data in the non-volatile memory is:
Tmax×N;

where, Tmax is the maximum number of erases for each memory block of the non-volatile memory; and

N is the number of memory blocks the non-volatile memory containing data.

As to the embedded system 1 adopting the balanced data access method, the maximum number of writing data into the non-volatile memory 10 is:
Tmax×N+M;

Tmax is the maximum number of erases for each memory block of the non-volatile memory 10;

N is the number of memory blocks of the non-volatile memory containing data; and

M is the number of memory blocks of the non-volatile memory containing no data.

Therefore, the ratio of the performance of the two is (N+M)/N. It is obvious that the embedded system 1 adopting the balanced data access method has a better performance. If the non-volatile memory 10 of the embedded system 1 adopting the balanced data access method is filled up with data, then M is equal to zero and the performance will be the same regardless of whether or not adopting the balanced data access method in the embedded system.

Further, if the data in a memory block of the non-volatile memory 10 is modified repeatedly until the memory block cannot be erased anymore, then the non-volatile memory 10 is damaged and the performance for both will be the minimum. As to the traditional embedded system not adopting the balanced data access method, the maximum number of writing data into the non-volatile memory is Tmax (Tmax refers to the maximum number of erasing the non-volatile memory); and as to the embedded system 1 adopting the balanced data access method, the maximum number of erasing the non-volatile memory 10 is Tmax×(M+1); where M is the quantity of memory blocks of the non-volatile memory containing no data.

Therefore, the performance ratio is (M+1). It is obvious that the embedded system 1 adopting the balanced data access method has a better performance. However if the non-volatile memory of such embedded system is filled up with data, then M is zero and the performance will be the same regardless of adopting or not adopting the balanced data access method.

While the invention has been described by means of specific embodiments, numerous modifications and variations could be made thereto by those skilled in the art without departing from the scope and spirit of the invention set forth in the claims.

1. A method for balancing data access to non-volatile memory, comprising:
sorting a block number of an unwritten memory block of a non-volatile memory with a queue structure, thereby if a data in a memory block of said non-volatile memory is erased, the block number of said memory block of which said data being erased is appended to a tail of said queue; and if a data is written into said non-volatile memory, a block number of said memory block is obtained from the head of said queue and written into a memory block corresponding to said block number while deleting said block number from said queue.

2. The method of claim 1, wherein said non-volatile memory is installed in an embedded system, and said embedded system comprises a driver, a control program, a random access memory, and an arithmetic unit; wherein said non-volatile memory saves data; said driver controls reading, writing, and erasing said non-volatile memory; said control program sorts said block number of said non-volatile memory with a queue structure and selectively adding and erasing said block number from said queue; said random access memory saves a logical mapping of said non-volatile memory, a code of said driver, and a code of said control program; and said arithmetic unit controls the operation of all components in said embedded system, such that when said embedded system is initialized, said control program sorts said block number of said unwritten memory block with a queue structure.

3. The method of claim 2, wherein said block number of said memory block, in which a data is erased when said driver erases data from any one of said memory blocks, is appended to the tail of said queue.

4. The method of claim 2, wherein said control program obtains a block number of said memory block from the head of said queue after said driver modifies a data in one of said memory blocks and writes said data back into said non-volatile memory, and then writes said modified data into said memory block corresponding to said block number while deleting said block number from said queue.

5. The method of claim 2, wherein said control program obtains a block number of said memory block from the head of said queue if said driver writes a new data into said non-volatile memory, and then writes said new data into a memory block corresponding to said block number while deleting said block number from said queue.

6. The method of claim 2, wherein said queue is saved in said random access memory, and said control program manages the sorting process of said queue and controls said driver for reading, writing, and erasing said non-volatile memory and saves a data selectively read from, modified for, and written into said memory block in said random access memory.
